(19) United States
(12) Patent Application Publication
(10) Pub. No.: US 2009/0181587 A1
(43) Pub. Date: Jul. 16, 2009

(54) FUNCTIONAL SHEET FOR DELIVERING LAUNDRY ACTIVES IN LOW-TEMPERATURE WATER

(75) Inventors: Joo-Young KANG, Daejeon (KR); Gug-In Jeong, Daejeon (KR); Sang-Woon Kwak, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: LG HOUSEHOLD & HEALTH CARE LTD., Seoul (KR)

(21) Appl. No.: 12/348,031

(22) Filed: Jan. 2, 2009

Related U.S. Application Data
(60) Provisional application No. 61/079,966, filed on Jul. 11, 2008.

(30) Foreign Application Priority Data
Jan. 4, 2008 (KR) 10-2008-0001372
Jan. 4, 2008 (KR) 10-2008-0001373

(51) Int. Cl. D06M 23/02; C11D 17/00

(52) U.S. Cl. 442/59; 428/305.5; 428/411.1; 428/446; 428/480; 428/523

(57) ABSTRACT

Disclosed are a functional sheet including a first substrate applied or impregnated with an active ingredient, which is to be used in low temperature water at 0° C. to 30° C., wherein the active ingredient is to be physically or chemically adsorbed on a second substrate in the low temperature water, and remain on the second substrate after removal of the low temperature water, as the first substrate, a substrate having a water contact angle of 90° or less is used so that 70% or more of the active ingredient applied or impregnated to the first substrate can be released in the low temperature water at 0° C. to 30° C. within 5 minutes; and another functional sheet including a first substrate applied or impregnated with an active ingredient, which is to be used in low temperature water at 0° C. to 30° C., wherein the active ingredient is to be physically or chemically adsorbed on a second substrate in the low temperature water, and remain on the second substrate after removal of the low temperature water, the functional sheet has light transmittance of 2 to 20%, so that 70% or more of the active ingredient applied or impregnated to the first substrate can be released in the low temperature water at 0° C. to 30° C. within 5 minutes.

This Non-Provisional U.S. patent application claims priority of the Provisional U.S. Application No. 61/079,966, filed Jul. 11, 2008, the entire disclosures of which are hereby incorporated by reference.

Further, this application claims the benefit of Korean Patent Application Nos. 10-2008-1372 and 10-2008-1373, filed Jan. 4, 2008 in Korea, which are hereby incorporated by reference in their entirety for all purposes as if fully set forth herein.

### TECHNICAL FIELD

The present invention relates to a functional sheet impregnated or applied with an active ingredient, such as a fabric softener, capable of being released in low temperature water.

### BACKGROUND ART

In washing clothes, fabrics, etc., a general detergent and an adjuvant have been used. The detergent plays a role of removing stains existing on clothes or fabrics, and is removed together with washing water.

Unlike a detergent, there are some adjuvants, which remain in a cloth, etc. and perform specific functions even after washing, such as a softener for softening texture of a cloth or restoring the texture to its original state by preventing a texture change caused by washing, an antibacterial agent for preventing spread and propagation of bacteria and larvae, an antistatic agent for improving wearing comfort by suppressing occurrence of static electricity caused by the action of a frictional force in a cloth, etc. During a washing process, such adjuvants are poured at a different stage from a detergent so as to appropriately perform the functions. In general, washing is carried out by a soaking step for a predetermined standby time upon pouring of the detergent, and then by the steps of washing, rinsing and spinning. Such adjuvants are poured and used in a final rinsing step or in a drying step following spinning.

A detergent used for a washing machine is usually processed as powder, and is used by a pack unit. Also, in hand-washing, some solid-type detergents are used. However, an adjuvant, such as a softener, an antistatic agent, an antibacterial agent, etc. is usually made into liquid form and is packed by a bottle or vessel unit. Especially, most of commercially available household softeners are made into liquid form, and thus have a lot of disadvantages, such as inconvenience by weight thereof in purchase and/or use, wastefulness, inconvenience of pouring, and difficulty in quantitative use.

Meanwhile, a sheet type fabric softener for a drying machine, which functions only at high temperatures of the drying machine, unlike a liquid type fabric softener used for a rinsing process of a general washing machine, is commercially available. As shown in FIG. 2, when laundry is dried in a drying machine, moisture in the laundry is changed into high temperature steam by heat, and then the laundry is swelled under such a high temperature steam atmosphere. Then, by evaporation and friction, an active ingredient is released from the sheet type fabric softener for the drying machine and is forcedly adsorbed on fabrics.

### BRIEF DESCRIPTION OF THE DRAWINGS

FIG. 1 schematically illustrates a mechanism of performing the function of a functional sheet according to an embodiment of the present invention.

FIG. 2 schematically illustrates a mechanism of performing the function of a conventional sheet type fabric softener for a drying machine.

FIG. 3 illustrates a water contact angle.

FIG. 4 shows photographs of water contact angles of various first substrates.

FIG. 5 shows photographs of light transmittance of various first substrates and functional sheets.

FIG. 6 is a graph illustrating the results of a water permeability, a release ratio, and a softening effect of functional sheets obtained from Comparative Examples 2 to 5 and Examples 4 to 7.

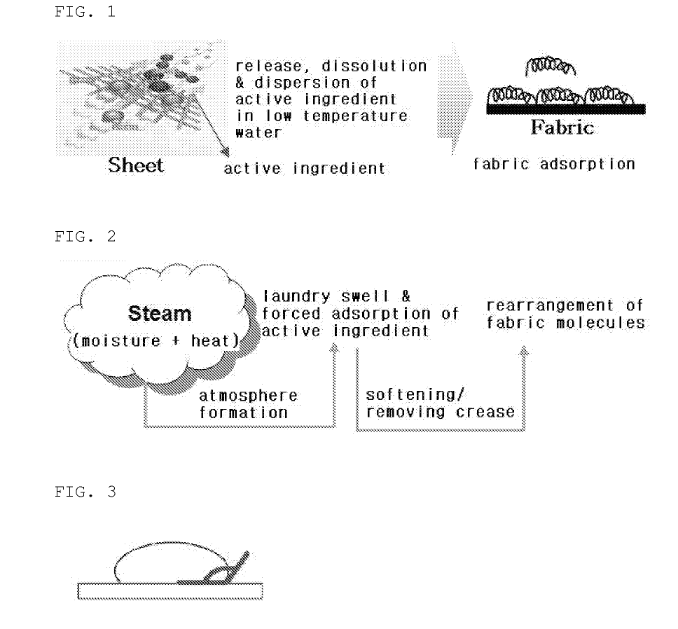

### DISCLOSURE OF THE INVENTION

It is an object of the present invention to provide a functional sheet impregnated/applied with an active ingredient that can be adsorbed on clothes and perform a specific function even after the completion of washing, unlike a detergent, in water-washing. The active ingredient can be easily released from the sheet and easily adsorbed onto a second substrate such as clothes, even in low temperature water.

In the present invention, during treatment with washing/rinsing water, water can easily penetrate into a functional sheet applied/impregnated with an active ingredient, and thus the active ingredient on the sheet can be easily released in low temperature water.

In accordance with an aspect of the present invention, there is provided a functional sheet including a first substrate applied or impregnated with an active ingredient, which is to be used in low temperature water at 0° C. to 30° C., wherein the active ingredient is to be physically or chemically adsorbed on a second substrate in the low temperature water, and remain on the second substrate after removal of the low temperature water, and as the first substrate, a substrate having a water contact angle of 90° or less is used so that 70% or more of the active ingredient applied or impregnated to the first substrate can be released in the low temperature water at 0° C. to 30° C. within 5 minutes.

Also, in the present invention, during treatment with washing/rinsing water, water can easily penetrate into a functional sheet applied/impregnated with an active ingredient, thereby facilitating water dispersibility of the active ingredient. Thus, the active ingredient on the sheet can be easily released in low temperature water.

In accordance with another aspect of the present invention, there is provided a functional sheet including a first substrate applied or impregnated with an active ingredient, which is to be used in low temperature water at 0° C. to 30° C., wherein the active ingredient is to be physically or chemically adsorbed on a second substrate in the low temperature water, and remain on the second substrate after removal of the low temperature water, and the functional sheet has light transmittance of 2 to 20%, so that 70% or more of the active ingredient applied or impregnated to the first substrate can be released in the low temperature water at 0° C. to 30° C. within 5 minutes.

In the present application, a first substrate refers to a carrier or a mediator for transferring an active ingredient to low temperature water, that is, a sheet capable of being impregnated or applied with the active ingredient to be used.

In the present application, a second substrate refers to a target (such as clothes or fabrics) on which the active ingredient is adsorbed in low temperature water, that is, laundry.

Hereinafter, the present invention will be explained in more detail.

An active ingredient such as a softener is put in a final rinsing step so that the active ingredient can be adsorbed on clothes after completion of washing, and can perform a specific function. In general, a softener is used in a liquid state because the softener is required to be dispersed in low temperature water and adsorbed on clothes for a short rinsing time within 5 minutes. However, a softener in a liquid state has disadvantages such as inconvenience by weight thereof in purchase and/or use, wastefulness, inconvenience of pouring, and difficulty in quantitative use. Accordingly, in order to the problems of a liquid type softener, the present invention provides the active ingredient applied or impregnated to a porous substrate. In the case of a functional sheet of which a substrate is applied or impregnated with an active ingredient, most of the active ingredient is required to be released from the substrate in low temperature water and to be adsorbed on a second substrate (for example, laundry), in a short rinsing time ranging from 3 to 5 minutes.

The present invention is characterized by using a substrate having a water contact angle of 90° or less as a first substrate in order to provide a functional sheet capable of releasing 70 to 100% of the active ingredient applied or impregnated to the first substrate within 5 minutes under normal rinsing conditions, for example, in low temperature water at room temperature, especially, at 0 to 30° C., preferably at 0 to 25° C.

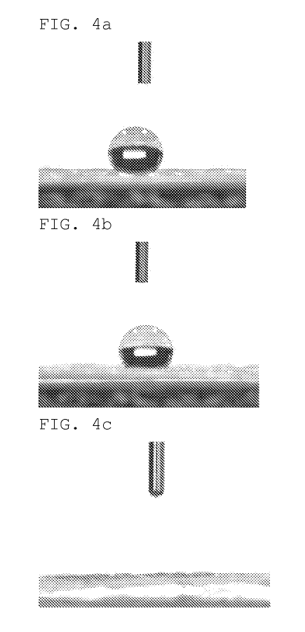

The water contact angle indicates a contact angle between a water-drop and a surface (see FIG. 3) when the water-drop is not absorbed by the surface and instead forms on the surface by surface tension. The contact angle changes according to the interface active property of the surface, and is decreased by increasing hydrophilicity of the surface.

When a hydrophilic substrate having a water contact angle of 90° or less is used as a first substrate, water can easily penetrate into a functional sheet applied or impregnated with an active ingredient in a washing water/rinsing water treatment step, and thus the active ingredient on the sheet can be easily released, even in low temperature water. On the other hand, when a water contact angle of a first substrate is more than 90°, an active ingredient cannot be stably applied or impregnated to the first substrate. Even in the case where an active ingredient is forcedly adhered to the first substrate, it is difficult to penetrate low temperature water, and thus the active ingredient cannot be easily dispersed from the first substrate in low temperature water and adsorbed on a second substrate.

Actually, in the case of a non-woven fabric not treated with a hydrophilic emulsion, the water contact angle was 120°. When the non-woven fabric was treat with a hydrophilic silicon based surfactant as a hydrophilic emulsion with a concentration within a range of 50˜100 ppm, the water contact angle exceeded 90°. When such a non-woven fabric is used, an active ingredient was not stably and sufficiently applied to the non-woven fabric.

The first substrate having a water contact angle of 90° or less may be obtained by surface-treating a sheet made of a hydrophobic polymer fiber with a hydrophilic emulsion, or may be a hydrophilic natural fiber or a sheet made of a hydrophilic polymer.

The hydrophilic emulsion according to the present invention is a material which can provide hydrophilicity by changing an interface characteristic, such as a hydrophilic surfactant, and a material capable of being used as the hydrophilic emulsion may be easily selected by a skilled person in the art. For example, when a non-woven fabric is used as a first substrate, a hydrophilic silicon based surfactant, etc. may be used. The use amount of a hydrophilic emulsion may be varied according to the kind of the first substrate and the hydrophilic emulsion, but may be within a range of about 0.01 to 20 parts by weight with respect to 100 parts by weight of the first substrate. Also, the use amount of the hydrophilic emulsion may be appropriately selected by repeatedly carrying out tests in order to achieve a water contact angle of 90° or less.

Hydrophilic surface treatment is for physically or chemically attaching a hydrophilic emulsion having a hydrophilic group to a sheet made of a polymer fiber.

Non-limiting examples of the hydrophilic group include sulfonate salt, sulfuric acid, carboxylate salt, carboxylic acid, phosphate salt, phosphoric acid, hydroxyl group (OH), etc. Also, as the hydrophilic emulsion, a silicon (Si) containing inorganic polymer (for example, composite metal oxide) or a silicon (Si) organic polymer may be used. In order to enhance hydrophilicity, the inorganic polymer may have a porous structure (for example, a hollow tube-type porous structure).

When a polymer is used as the hydrophilic emulsion, non-limiting examples of a hydrophilic monomer include an ethylenically unsaturated monomer containing a carboxylic group, an ethylenically unsaturated monomer containing a sulfonic acid group, an ethylenically unsaturated monomer containing a hydroxyl group, etc. As the ethylenically unsaturated monomer containing the carboxylic group, carboxylic acid monomers, such as acrylic acid, methacrylic acid, itaconic acid, maleic acid, etc. may be used. As the ethylenically unsaturated monomer containing the sulfonic acid group, styrene sulfonic acid, naphthalene sulfonic acid, etc. may be used. As the ethylenically unsaturated monomer containing the hydroxyl group, hydroxyl alkyl methacrylate of which an alkyl group has a carbon number of 1 to 12 is preferable, and also hydroxyl ethyl methacrylate, hydroxyl propyl methacrylate, or hydroxyl butyl methacrylate, etc. may be used.

In hydrophilic surface treatment, a coating solution containing the hydrophilic emulsion is applied to a substrate by using various methods, such as dip coating, die coating, roll coating, comma coating, doctor blade, spray, gravure printing, or a combination thereof. The coating may be carried out once or twice, and as required, a conventional process such as heating, and drying, may be further carried out to form a hardened coating layer.

Meanwhile, a first substrate having a water contact angle of 90° or less is preferably a porous substrate. When an active ingredient is applied or impregnated to a porous substrate, the surface area of the active ingredient is increased, thereby facilitating the release and dispersion of the active ingredient from the porous substrate in low temperature water. Thus, it is possible to shorten release and dispersion time of the active ingredient. Herein, a functional sheet applied or impregnated with the active ingredient can also have the optimum porosity per unit area, which facilitates the penetration of low temperature water into the functional sheet and facilitates water dispersibility of the active ingredient. Also, in the case of a functional sheet of which a pore structure can be maintained even after an active ingredient is applied or impregnated, the active ingredient can have a wide specific surface area, and thus can be easily released in low temperature water.

Also, in order to provide a functional sheet capable of releasing 70 to 100% of an active ingredient impregnated to the first substrate within 5 minutes under normal rinsing conditions, for example, in low temperature water at room temperature, especially, at 0 to 30° C., preferably at 0 to 25° C., the present invention is characterized in that the porosity of the functional sheet is adjusted in such a manner that light transmittance can be within a range of 2˜20%, and preferably of 5˜10%.

Preferably, in the functional sheet, the active ingredient is impregnated or applied in an amount within a range of 0.1˜20 mg/cm² per unit area, and the porosity causes light transmittance within a range of 2˜20%.

In the present application, the light transmittance is calculated by a light transmissive area to a total area in the functional sheet (or the first substrate) impregnated or applied with the active ingredient. Herein, the light transmittance is calculated on the assumption that the functional sheet or the first substrate is opaque.

In the functional sheet or the first substrate, pores are not uniformly formed, and thus the light transmittance may vary according to measured spots. Accordingly, the light transmittance is preferably obtained by an average value of overall light transmittance of the functional sheet or the first substrate. For example, a circle with a diameter of 1 mm is sampled, and light transmittance of the circle is calculated. In this manner, 20 randomly selected circles are calculated and their average is obtained. In calculating the light transmittance, connecting points of a non-woven fabric is excluded from areas to be measured because water cannot penetrate into the connecting points.

The light transmittance corresponds to an area with which water can come in contact, and to porosity, that is, water permeability, allowing water to penetrate into the functional sheet in an immersed state. In directly calculating the porosity or water permeability of the functional sheet impregnated with the active ingredient, in an immersed state, it is impossible to accurately measure the porosity or water permeability because the active ingredient is released during the measurement. Accordingly, the porosity or water permeability allowing water to penetrate is estimated by measurement of light transmittance.

If the light transmittance of the functional sheet according to the present invention is 2% or more, water can easily penetrate into the functional sheet during a washing or rinsing process, thereby increasing a specific surface area on which an active ingredient coated on a first substrate can come into contact with water. Thus, even in low temperature water, the active ingredient on the first substrate can be easily released. On the other hand, if the light transmittance of the functional sheet according to the present invention is less than 2%, an active ingredient cannot be easily dispersed in water, and if the light transmittance exceeds 20%, the amount of an active ingredient (such as a fabric softener) carried by a first substrate is too small to display its function.

In the present invention, low temperature water includes an aqueous solution and aqueous dispersion as well as water.

Also, the present invention includes a functional sheet capable of releasing 70% or more of an active ingredient applied or impregnated to the first substrate within 5 minutes in low temperature water at room temperature, especially, at 0 to 30° C. by stirring.

Non-limiting examples of the active ingredient that can perform a specific function by adsorbing on clothes even after the completion of washing include a softener, an aromatic agent, an antistatic agent, a stabilizer, a colorant, a preservative, an antibacterial agent, an electrolyte, an optical brightener, a bleaching agent, etc.

Meanwhile, in order to adjust the light transmittance of the functional sheet within a range of 2 to 20%, a first substrate is preferably a porous substrate, and the first substrate's own light transmittance is preferably within a range of 20 to 50%. When a porous substrate is impregnated or applied with an active ingredient, the specific surface area of a functional sheet is increased, thereby facilitating release and low temperature water dispersion of the active ingredient from the porous substrate. Thus, it is possible to shorten release and dispersion times of the active ingredient. Herein, a functional sheet applied or impregnated with an active ingredient can also have the optimum porosity per unit area, which facilitates the penetration of low temperature water into the functional sheet and facilitate water dispersibility of the active ingredient. Also, in the case of a functional sheet of which a pore structure can be maintained even after an active ingredient is applied or impregnated, the active ingredient can have a wide specific surface area, and thus can be easily released in low temperature water.

Examples of a material for the first substrate include natural materials such as cotton, hemp, linen, silk, etc., synthesized materials, such as rayon, cellulose ester, polyvinyl derivative, polyolefin based, polyamide based, polyester based, etc., or paper.

The first substrate may be a woven fabric or a non-woven fabric. Preferably, the first substrate is a non-woven fabric manufactured by using at least one polymer fiber selected from the group including polypropylene, polyethylene terephthalate, polyethylene, nylon, rayon, pulp and acryl, via thermal bonding, air through, spun bonding or melt-blown. Herein, the material for the first substrate is preferably polyethylene (PE), polypropylene (PP), or polyethylene terephthalate (PET) due to low cost. In addition, in the product made of the material, shape stability is improved and the amount of fluffs caused by washing is decreased. Since the functional sheet of the present invention is used in low temperature water unlike a sheet type fabric softener for a drying machine, the first substrate does not require heat resistance at high temperatures.

Also, since the functional sheet is required to be easily folded from the standpoint of convenience of circulation, the first substrate is preferably flexible.

Herein, fineness of the polymer fiber forming the first substrate is preferably within a range of 1 to 10 deniers, more preferably of 3 to 7 deniers. An active ingredient and/or low temperature water can be easily impregnated within the range of the fineness by capillary action of a free space between respective fibers.

Basis weight indicates mass (g) per 1 m², and the basis weight of the first substrate may be within a range of 10 to 100, preferably of 15 to 50. If the basis weight is less than 10, the active ingredient is impregnated/applied in a small amount. On the other hand, if the basis weight is more than 100, a space into which water can penetrate is significantly reduced, and thus the production of a functional sheet is difficult and the weight of the first substrate becomes too heavy.

For formulation on a sheet, the active ingredient is preferably in a liquid state at 60° C. or more, and in a solid state at room temperature, especially, at 30° C. or less. In manufacturing, the active ingredient is preferably in a liquid state at high temperatures, especially at 60° C. or more so as to be easily impregnated or applied. Meanwhile, in storage, the active ingredient is required to maintain its shape without flowing, and thus is preferably in a solid state. If an active ingredient in a liquid state is impregnated or applied to a porous substrate such as a non-woven fabric at room temperature, it is impossible to have formulation due to slipperiness.

In the low temperature water active type functional sheet according to the present invention, the applied or impregnated amount of the active ingredient may be adjusted within a range of 100 to 500 parts by weight, preferably of 200 to 400 parts by weight, with respect to 100 parts by weight of a first substrate. In other words, the applied or impregnated amount of the active ingredient per unit area on the functional sheet may be within a range of 0.1˜20 mg/cm². On the other hand, in the case of a sheet type fabric softener for a high temperature drying machine, the amount of an applicable active ingredient is small.

If the active ingredient is a softener, a softener selected from the group including cationic surfactants represented by following Formulas 1, 2, and 3 may be used so as to facilitate the release of the softener from a first substrate during a rinsing process in low temperature water.

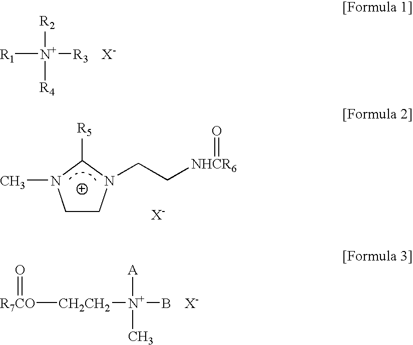

In above formulas,

each of R₁, R₂, R₅, R₆ and R₇ independently represents a linear or branched C₇-C₂₁ alkyl group, C₇-C₂₁ alkenyl group, or C₇-C₂₁ alkynyl group,

each of R₃ and R₄ independently represents a C₁-C₄ alkyl group,

A represents a C₁-C₄ alkyl group, (CH₂)ₙOH or (CH₂)ₘOCOR₈,

B represents (CH₂)ₙOH or (CH₂)ₘOCOR₉,

herein, each of n and m independently represents an integer of 1 to 4,

each of R₈ and R₉ independently represents a linear or branched C₇-C₂₁ alkyl group, C₇-C₂₁ alkenyl group, or C₇-C₂₁ alkynyl group, and

X represents halogen or C₁-C₄ alkyl sulfate, preferably represents F, Cl, I, Br, CH₃SO₄ or CH₃CH₂SO₄.

The cationic surfactant preferably satisfies the following Mathematical Expression 1.

Q/T≧0.6 [Mathematical Expression 1]

Herein, T represents the total area of peaks based on the C₇-C₂₁ alkyl group, the C₇-C₂₁ alkenyl group, and the C₇-C₂₁ alkynyl group in R₁, R₂, R₅, R₆, R₇, A and B, which is detected by HPLC (high pressure liquid chromatography) or GC (gas chromatography), and

Q represents the total area of peaks based on the saturated hydrocarbon (that is, the C₇-C₂₁ alkyl group) in R₁, R₂, R₅, R₆, R₇, A and B, which is detected by HPLC (high pressure liquid chromatography) or GC (gas chromatography).

In the cationic surfactant, if the ratio of C₇-C₂₁ alkyl substituents according to analysis by HPLC (high pressure liquid chromatography) or GC (gas chromatography), is 0.6 or more, the surfactant can be easily released/dispersed in low temperature water. The ratio of alkyl substituents is preferably in a range of 0.6 to 0.9, and more preferably of 0.7 to 0.9. If the ratio of alkyl substituents is less than 0.6, the cationic surfactant cannot be firmly applied to and carried by a sheet, and thus can be easily released from the sheet.

Also, the cationic surfactant preferably satisfies the following Mathematical Expression 2.

P/T≧0.9 [Mathematical Expression 2]

Herein, P represents the total area of peaks based on the C₁₂-C₁₈, alkyl group, the C₁₂-C₁₈, alkenyl group, and the C₁₂-C₁₈, alkynyl group in R₁, R₂, R₅, R₆, R₇, A and B, which is detected by HPLC (high pressure liquid chromatography) or GC (gas chromatography), and

T represents the same as defined above.

In the cationic surfactant, if the ratio of long chain substituents (a C₁₂-C₁₈, alkyl group, a C₁₂-C₁₈ alkenyl group and a C₁₂-C₁₈ alkynyl group), analyzed by HPLC (high pressure liquid chromatography) or GC (gas chromatography), is 0.9 or more, the surfactant can be easily applied to and carried by a first substrate by Van der Waals' force. Moreover, before a functional sheet is put into water, an active ingredient including the cationic surfactant is not easily released from the functional sheet.

Also, the cationic surfactant preferably satisfies the following Mathematical Expression 3.

0.6≦(Q₁/T₁)*X+(Q₂/T₂)*Y+(Q₃/T₃)*Z≦0.9 [Mathematical Expression 3]

Herein, T₁ represents the total area of peaks based on the C₇-C₂₁ alkyl group, the C₇-C₂₁ alkenyl group, and the C₇-C₂₁ alkynyl group in R₁ and R₂, which is detected by HPLC (high pressure liquid chromatography),

Q₁ represents the total area of peaks based on the saturated hydrocarbon (that is, the C₇-C₂₁ alkyl group) in R₁ and R₂, which is detected by HPLC (high pressure liquid chromatography),

T₂ represents the total area of peaks based on the C₇-C₂₁ alkyl group, the C₇-C₂₁ alkenyl group, and the C₇-C₂₁ alkynyl group in R₅ and R₆, which is detected by GC (gas chromatography),

Q₂ represents the total area of peaks based on the saturated hydrocarbon (that is, the C₇-C₂₁ alkyl group) in R₅ and R₆, which is detected by GC,

T₃ represents the total area of peaks based on the C₇-C₂₁ alkyl group, the C₇-C₂₁ alkenyl group, and the C₇-C₂₁ alkynyl group in R₇, A and B, which is detected by GC,

Q₃ represents the total area of peaks based on the saturated hydrocarbon (that is, the C₇-C₂₁ alkyl group) in R₇, A and B, which is detected by GC,

X represents the weight ratio of the compound represented by Formula 1, with respect to the total use amount of cationic surfactant,

Y represents the weight ratio of the compound represented by Formula 2, with respect to the total use amount of cationic surfactant, and

Z represents the weight ratio of the compound represented by Formula 3, with respect to the total use amount of cationic surfactant.

Also, the cationic surfactant preferably satisfies the following Mathematical Expression 4.

(P₁/T₁)*X+(P₂/T₂)*Y+(P₃/T₃)*Z≧0.9 [Mathematical Expression 4]

Herein, P₁ represents the total area of peaks based on the C₁₂-C₁₈, alkyl group, the C₁₂-C₁₈, alkenyl group, and the C₁₂-C₁₈, alkynyl group in R₁ and R₂, which is detected by HPLC (high pressure liquid chromatography),

P₂ represents the total area of peaks based on the C₁₂-C₁₈, alkyl group, the C₁₂-C₁₈, alkenyl group, and the C₁₂-C₁₈, alkynyl group in R₅ and R₆, which is detected by GC (gas chromatography),

P₃ represents the total area of peaks based on the C₁₂-C₁₈, alkyl group, the C₁₂-C₁₈, alkenyl group, and the C₁₂-C₁₈, alkynyl group in R₇, A and B, which is detected by GC (gas chromatography), and

each of T₁, T₂, T₃, X, Y, and Z is the same as defined above.

Examples of the softener include a cation containing a rape extract (a natural softening component), dimethyl dialkyl ammonium chloride, EQ (ester quat.) and imidazoline.

Meanwhile, the functional sheet of the present invention may be used in combination with a dispersant. When an emulsifier having high dispersibility is used, the active ingredient can be uniformly dispersed in low temperature water.

The content of the emulsifier is preferably 50 parts by weight or less with respect to 100 parts by weight of the total active ingredient composition to be impregnated to a first substrate. If the content is more than 50 parts by weight, it is inconvenient to use a manufactured sheet because its slipperiness.

Examples of a preferable emulsifier include emulsifiers with HLB 2 to 18. The emulsifier is advantageous in convenience in sheet manufacture, and can completely release and disperse an active ingredient impregnated to the manufactured sheet to washing water during washing. Accordingly, an emulsifier with HLB 8 to 12 is more preferable. Herein, HLB indicates Hydrophilic-Lipophile Balance.

The functional sheet of the present invention may be manufactured by applying or impregnating an active ingredient to a first substrate via various methods, such as dip coating, die coating, roll coating, comma coating, doctor blade, spray, gravure printing, or a combination thereof.

### MODE FOR CARRYING OUT THE INVENTION

Reference will now be made in detail to the preferred embodiments of the present invention. However, the following examples are illustrative only, and the scope of the present invention is not limited thereto.

### EXPERIMENTAL EXAMPLES

A contact angle meter (KRUSS, FM40, EASY DROP) was used to measure water contact angles on a 30 gsm high density polypropylene spun-bonded non-woven fabric (a), a 15 gsm low density polypropylene spun-bonded non-woven fabric (b), and a 30 gsm high density polypropylene spun-bonded non-woven fabric hydrophilized by 5,000 ppm of hydrophilic silicon surfactant (c), and FIG. 4 shows the measured results.

As shown in FIG. 4, the polypropylene non-woven fabrics (a) and (b), which were not hydrophilized, showed a water contact angle of about 120°. On the other hand, in the case of the hydrophilized polypropylene non-woven fabric (c), it was impossible to measure a water contact angle because all water-drops dropped on the surface were absorbed (water contact angle: 0).

### Comparative Example 1, Examples 1 to 3

A functional sheet was fabricated by using a first substrate having a water contact angle as noted in Table 1, preparing a substrate impregnation composition by active ingredients and contents according to Table 1, and carrying press-coating and cooling steps. Herein, during press-coating, the substrate impregnation composition was present at 60° C. and in a liquid state. Cooling temperature was 25° C.

The first substrate used for Comparative Example 1 was an unhydrophilized spun-bonded polypropylene non-woven fabric. In Examples 1 to 3, as the first substrate, spun-bonded polypropylene non-woven fabrics, which were hydrophilized by using a hydrophilic silicon surfactant in different amounts, were used.

In Comparative Example 1, and Examples 1 to 3, the water absorption ratio of each non-woven fabric used as the first substrate was calculated by water-saturating the non-woven fabric in low temperature water at 20° C. for 5 minutes, measuring the difference between weights before and after water-saturation, and dividing the initial weight by the difference.

TABLE 1

| | Comp. | | Unit (wt %) | |
|---|---|---|---|---|
| component | Exp. 1 | Exp. 1 | Exp. 2 | Exp. 3 |
| Non-woven fabric (first | 0 (120°) | 0.1 (im- | 0.5 (im- | 1 (im- |
| substrate) water | | possible | possible | possible |
| absorption ratio (%)/ | | to | to | to |
| (water contact angle) | | measure) | measure) | measure) |
| softener: Ester | 20 | 20 | 30 | 30 |
| Quat(EQ, Formula 2) | | | | |
| Formulation | 20 | 20 | 10 | 10 |
| dispersion: glycerol | | | | |
| monostearate | | | | |
| Formulation | | | 10 | 10 |
| dispersion: glycerol | | | | |
| distearate | | | | |
| emulsifier: | 3 | 3 | 3 | 3 |
| polyoxyethylene | | | | |
| sorbitan ester Tween- | | | | |
| 81 (HLB 10) | | | | |
| Stearamidopropyl | 10 | 10 | 20 | 30 |
| dimethylamine | | | | |
| * other additives | quantum | quantum | quantum | quantum |
| | satis | satis | satis | satis |
| fragrance | 10 | 10 | 10 | 10 |

* Other additives: additives, such as colorants, preservatives, antioxidants, defoamers, etc. in a trace amount.

On the functional sheets obtained by Examples 1 to 3 and Comparative Example 1, performance tests were carried out by the following method. Table 2 shows the results.

### Experiment 1: Test on Solubility

On the functional sheets obtained by Examples 1 to 3 and Comparative Example 1, solubility and dispersibility of an active ingredient in low temperature water was measured. 3 l of 2° C. low temperature water was poured into a beaker, and each functional sheet was put therein, followed by stirring for 5 minutes. Then, the difference between weights before and after the functional sheet is treated and dried was measured to test the solubility of the active ingredient. The solubility measurement was repeatedly carried out three times or more.

| | Excellent | good | normal | Poor |
|---|---|---|---|---|
| Test result | (⊚) | (◯) | (Δ) | (X) |
| Dissolved | 90% or more | 80~90% | 70~80% | 70% or less |
| amount | | | | |

### Experiment 2: Test on a Softening Effect

A commercially available 100% cotton towel was repeatedly washed five times in a washing machine by using a normal detergent in a standard amount, and then was spin-dried. The spin-dried cotton towel, together with one sheet of each of the functional sheets obtained by Examples 1 to 3 and Comparative Example 1, was put in rinsing water (bath ratio 1:30, 25° C.), and was subjected to softening for 5 minutes. Then, the towel was spin-dried, and was subjected to conditioning for 24 hours at 20° C., with 65% RH. A feeling test was carried out through sensory evaluation by a skillful panelist, and softening evaluation score was given from 1 to 5. This test was repeatedly carried out three times or more, and the softening effect was measured by the average value.

| | Excellent | good | normal | Poor |
|---|---|---|---|---|
| Test result | (⊚) | (◯) | (Δ) | (X) |
| Softening | 4.5 or more | 3.5-4.5 | 2.5-3.5 | Less than |
| effect | | | | 2.5 |

### Experiment 3: Test on Absorbance

A test cloth was obtained by cutting a normal cotton cloth into 2×15 cm size pieces in both warp and weft directions, and carrying out softening in the same manner as described in Experiment 2 and conditioning at 20° C., with 65% RH for 24 hours. The test cloth was vertically suspended by a clamp and a balance weight, and the end of the test cloth was soaked in an aqueous solution including 0.1% soluble blue dyes. Then, the rise height of the blue dyes was measured after 20 minutes. This measurement was repeatedly carried out three times or more, and the absorbing effect was measured by the average value.

| | Excellent | good | normal | Poor |
|---|---|---|---|---|
| Test result | (⊚) | (◯) | (Δ) | (X) |
| height (mm) | 100 or more | 70-100 | 40-70 | Less than |
| | | | | 40 |

### Experiment 4: Test on Antistatic Property (Half Period)

On each test cloth, which was softened in the same manner as described in Experiment 4, and conditioned at 20° C., with 65% RH, for 24 hours, leakage speed of constant voltage was measured as follows. In this experiment, KS K-0555A and Static Voltmeter (Rothschild) were employed. The leakage speed of constant voltage was measured by calculating the time of reducing into the half of the initial voltage since initial voltage 150V was applied. This measurement was repeatedly carried out three times or more, and the average value was obtained.

| | Excellent | good | normal | Poor |
|---|---|---|---|---|
| Test result | (⊚) | (◯) | (Δ) | (X) |
| Leakage | 10 or less | 10-10² | 10²-10³ | 10³ or more |
| speed (sec) | | | | |

### Experiment 5: Test on Residual Fragrance

A cotton towel, which was softened in the same manner as described in Experiment 1, was evaluated by a panelist. Based on a score of 5, a test result was obtained through three measurements.

| | Excellent | good | normal | Poor |
|---|---|---|---|---|
| Test result | (⊚) | (◯) | (Δ) | (X) |
| Scores of | 4.5 or more | 3.5-4.5 | 2.5-3.5 | Less than |
| residual | | | | 2.5 |
| fragrance | | | | |

TABLE 2

| | | Comp. | | | |
|---|---|---|---|---|---|
| | | Exp. 1 | Exp. 1 | Exp. 2 | Exp. 3 |
| Performance | Softening | Δ | ⊚ | ⊚ | ⊚ |
| test | effect | | | | |
| | Residual | Δ | ⊚ | ⊚ | ⊚ |
| | fragrance | | | | |
| | Solubility | X | ⊚ | ⊚ | ⊚ |
| | Absorbance | X | ⊚ | ⊚ | ⊚ |
| | Antistatic | Δ | ⊚ | ⊚ | ⊚ |
| | property | | | | |
| | (half | | | | |
| | period) | | | | |

As noted in Table 2, unlike a conventional functional sheet using an unhydrophilized first substrate having a water contact angle of 120°, a functional sheet according to the present invention, which uses a hydrophilized first substrate having a water contact angle of 90° or less, can sufficiently perform a softening effect, residual fragrance, and an antistatic effect of an active ingredient impregnated to the functional sheet due to its high absorbance and high solubility in low temperature water.

### Comparative Examples 2 to 5 and Examples 4 to 7

An impregnation composition was prepared by using 20 parts by weight of Ester Quat (EQ, Formula 2) as a fabric softener, 20 parts by weight of glycerol monostearate as a formulation dispersion, 2 parts by weight of polyoxyethylene sorbitan ester Tween-81 (HLB 10) as an emulsifier, 10 parts by weight of stearamidopropyl dimethylamine as an adjuvant for softening, and 10 parts by weight of fragrance. Then, as the first substrate, a 30 gsm polypropylene spun-bonded non-woven fabric was used.

A functional sheet was fabricated by carrying press-coating and cooling steps. Herein, during press-coating, the substrate impregnation composition was present at 60° C. and in a liquid state. The cooling temperature was 25° C.

In each of functional sheets obtained from Comparative Examples 2 to 5, and Examples 4 to 7, an applied amount on a first substrate was adjusted according to distance between a first roller and a second roller used for press-coating, so as to adjust light transmittance as noted in Table 3.

<A Measurement Method of Light Transmittance>

Light transmittance of a 15 gsm polypropylene spun-bonded non-woven fabric, a 30 gsm polypropylene spun-bonded non-woven fabric, and a 30 gsm PET spun-bonded non-woven fabric as a first substrate, and light transmittance of functional sheets obtained from Comparative Examples 2 to 5, and Examples 4 to 7 were measured as follows.

The first substrate and respective functional sheets were analyzed by Image Analyzer (HIROX, Hi-scope KH-2400, ×200, distance between connecting points: 1˜2 mm), and the light transmittance was measured by a light transmissive area to the total area in a circle with a diameter of 1 mm. The light transmittance was an average value obtained by randomly sampling 20 areas. Herein, the connecting points of a non-woven fabric were excluded.

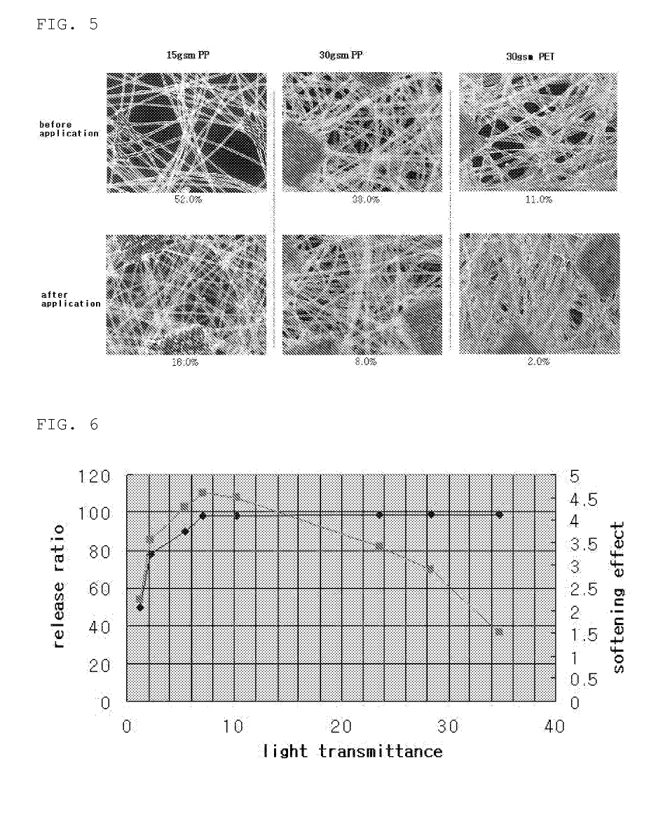

On the top of FIG. 5, light transmittance of the 15 gsm polypropylene spun-bonded non-woven fabric, the 30 gsm polypropylene spun-bonded non-woven fabric, and the 30 gsm PET spun-bonded non-woven fabric is shown, and on the bottom, light transmittance resulting from application of the impregnation composition on each of the non-woven fabrics is shown. Also, the light transmittance of the functional sheets obtained from Comparative Examples 2 to 5, and Examples 4 to 7 is shown in Table 3, and FIG. 6.

<A Method of Measuring Release Ratio>

On each of the functional sheets obtained from Comparative Examples 2 to 5, and Examples 4 to 7, solubility and dispersibility of an active ingredient in low temperature water was measured. 3 l of 20° C. low temperature water was poured into a beaker, and each functional sheet was put therein, followed by stirring for 1 minute. Then, the difference between weights before and after the functional sheet is treated and dried was measured to test the release ratio of the active ingredient. The release ratio measurement was repeatedly carried out three times or more. Table 3 and FIG. 6 show the results.

<A Method of Measuring a Softening Effect>

A commercially available 100% cotton towel was repeatedly washed five times in a washing machine by using a normal detergent in a standard amount, and then was spin-dried. The spin-dried cotton towel, together with one sheet of each of the functional sheets obtained by Comparative Examples 2 to 5, and Examples 4 to 7, was put in rinsing water (bath ratio 1:30, 25° C.), and was subjected to softening for 1 minute. Then, the towel was spin-dried, and was subjected to conditioning for 24 hours at 20° C., with 65% RH. A feeling test was carried out through sensory evaluation by a skillful panelist, and softening evaluation score was given from 1 to 5. This test was repeatedly carried out three times or more, and the softening effect was measured by the average value. Table 3 and FIG. 6 show the results.

| Test result | excellent | good | normal | Poor |
|---|---|---|---|---|
| Softening | 4.5 or more | 3.5-4.5 | 2.5-3.5 | Less than |
| effect | | | | 2.5 |

TABLE 3

| | Comp. | | | | | Comp. | Comp. | Comp. |
|---|---|---|---|---|---|---|---|---|
| | Exp. 2 | Exp. 4 | Exp. 5 | Exp. 6 | Exp. 7 | Exp. 3 | Exp. 4 | Exp. 5 |
| Light | 1.24 | 2.11 | 5.35 | 7.1 | 10.18 | 23.56 | 28.33 | 34.66 |
| transmittance | | | | | | | | |
| Release ratio | 50 | 78 | 90 | 98 | 98.5 | 99 | 99 | 99 |
| Softening | 2.24 | 3.56 | 4.3 | 4.6 | 4.5 | 3.4 | 2.9 | 1.5 |
| effect | | | | | | | | |

Light transmittance of a functional sheet indicates an area with which water can come in contact. It can be seen from Comparative Example 2 that if light transmittance of a functional sheet is less than 2%, water dispersion of an active ingredient was difficult. Also, as noted in results from Comparative Examples 3 to 5, in which despite high release ratio of 99%, a softening effect was low, it can be seen that if light transmittance is more than 20%, it is difficult to sufficiently impregnate a fabric softener to a non-woven fabric.

### INDUSTRIAL APPLICABILITY

As can be seen from the foregoing, the functional sheet according to the present invention, which is impregnated/applied with an active ingredient (such as a fabric softener) capable of adsorbing on clothes and performing a specific function after the completion of washing, can facilitate release of the active ingredient thereon in low temperature water, and also have advantages such as convenience of circulation, storage, and use, and quantitative use of the active ingredient.

1. A functional sheet comprising a first substrate applied or impregnated with an active ingredient, which is to be used in low temperature water at 0° C. to 30° C.,
wherein the active ingredient is to be physically or chemically adsorbed on a second substrate in the low temperature water, and remain on the second substrate after removal of the low temperature water, and
as the first substrate, a substrate having a water contact angle of 90° or less is used so that 70% or more of the active ingredient applied or impregnated to the first substrate is released in the low temperature water at 0° C. to 30° C. within 5 minutes.

2. The functional sheet as claimed in claim 1, wherein the substrate having the water contact angle of 90° or less is obtained by surface-treating a sheet made of a polymer by a hydrophilic emulsion, or is a sheet made of a hydrophilic polymer.

3. The functional sheet as claimed in claim 1, wherein the first substrate has a water contact angle of 0°.

4. The functional sheet as claimed in claim 2, wherein the hydrophilic emulsion is a hydrophilic silicon based surfactant.

5. The functional sheet as claimed in claim 2, wherein the hydrophilic emulsion used for surface-treating the polymer sheet is used in an amount within a range of 0.01 to 20 parts by weight, with respect to 100 parts by weight of the first substrate.

6. The functional sheet as claimed in claim 1, wherein the first substrate is a porous substrate.

7. The functional sheet as claimed in claim 2, wherein the polymer sheet to be surface-treated is made of polyethylene, polypropylene, or polyethylene terephthalate.

8. The functional sheet as claimed in claim 1, wherein the first substrate is a non-woven fabric or a woven fabric.

9. The functional sheet as claimed in claim 1, wherein, even after the active ingredient is applied or impregnated, a pore structure is maintained.

10. The functional sheet as claimed in claim 1, wherein the active ingredient is at least one material selected from the group including a softener, an aromatic agent, an antistatic agent, a stabilizer, a colorant, a preservative, an antibacterial agent, an electrolyte, an optical brightener, and a bleaching agent.

11. The functional sheet as claimed in claim 1, wherein the active ingredient is used in combination with an emulsifier or a dispersant.

12. The functional sheet as claimed in claim 11, wherein content of the emulsifier is 50 parts by weight or less, with respect to 100 parts by weight of a total active ingredient composition to be impregnated to the first substrate.

13. The functional sheet as claimed in claim 1, wherein the active ingredient is in a liquid state at 60° C. or more, and is in a solid state at 30° C. or less.

14. The functional sheet as claimed in claim 1, wherein the active ingredient is impregnated or applied on the functional sheet in an amount within a range of 0.1˜20 mg/cm² per unit area.

15. A functional sheet comprising a first substrate applied or impregnated with an active ingredient, which is to be used in low temperature water at 0° C. to 30° C.,
wherein the active ingredient is to be physically or chemically adsorbed on a second substrate in the low temperature water, and remain on the second substrate after removal of the low temperature water, and
the functional sheet has light transmittance ranging from 2 to 20%, so that 70% or more of the active ingredient applied or impregnated to the first substrate is be released in the low temperature water at 0° C. to 30° C. within 5 minutes.

16. The functional sheet as claimed in claim 15, wherein the first substrate is a porous substrate.

17. The functional sheet as claimed in claim 16, wherein, even after the active ingredient is applied or impregnated, a pore structure is maintained.

18. The functional sheet as claimed in claim 15, wherein the first substrate has light transmittance within a range of 20 to 50%.

19. The functional sheet as claimed in claim 15, wherein the active ingredient is at least one material selected from the group including a softener, an aromatic agent, an antistatic agent, a stabilizer, a colorant, a preservative, an antibacterial agent, an electrolyte, an optical brightener, and a bleaching agent.

20. The functional sheet as claimed in claim 15, which comprises the active ingredient applied thereon in an amount within a range of 0.1˜20 mg/cm² per unit area, and porosity with light transmittance within a range of 2˜20%.

21. The functional sheet as claimed in claim 15, wherein the active ingredient is used in combination with an emulsifier or a dispersant.

22. The functional sheet as claimed in claim 15, wherein the active ingredient is in a liquid state at 60° C. or more, and is in a solid state at 30° C. or less.

23. The functional sheet as claimed in claim 15, wherein the first substrate is polyethylene, polypropylene, or polyethylene terephthalate (PET).

24. The functional sheet as claimed in claim 15, wherein the first substrate is a non-woven fabric or a woven fabric.
